(19) United States
(12) Patent Application Publication
(10) Pub. No.: US 2006/0114050 A1
(43) Pub. Date: Jun. 1, 2006

(54) Minimizing i/f noise configuration for zif mixer

(75) Inventors: Vickram R Vathulya, San Jose, CA (US); Luca Lococo, Caen (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,573

(22) PCT Filed: Dec. 5, 2003
(86) PCT No.: PCT/IB03/05751

§ 371 Date: Jun. 15, 2005

Related U.S. Application Data
(60) Provisional application No. 60/434,552, filed on Dec. 19, 2002.

(51) Int. Cl. G06F 7/44

(52) U.S. Cl. 327/359

(57) ABSTRACT

A Gilbert cell (Q3-Q8) of a mixer (11) controls a differential output voltage between a pair of output terminals (OUT1, OUT2) of the mixer (11). A polysilicon resistor (R7) of the mixer (11) applies a differential loading to the differential output voltage. A pair of current sources (Q11, Q12) of the mixer (11) provide biasing currents to the Gilbert cell (Q3-Q8). A pair of resistors (R8, R9) of the mixer (11) impede a flow of DC current through the current sources (Q11, Q12), respectively.

The present invention generally relates to mixers. The present invention specifically relates to direct conversion mixers, down conversion mixers, and the arrangement of Gilbert cell type in such mixers.

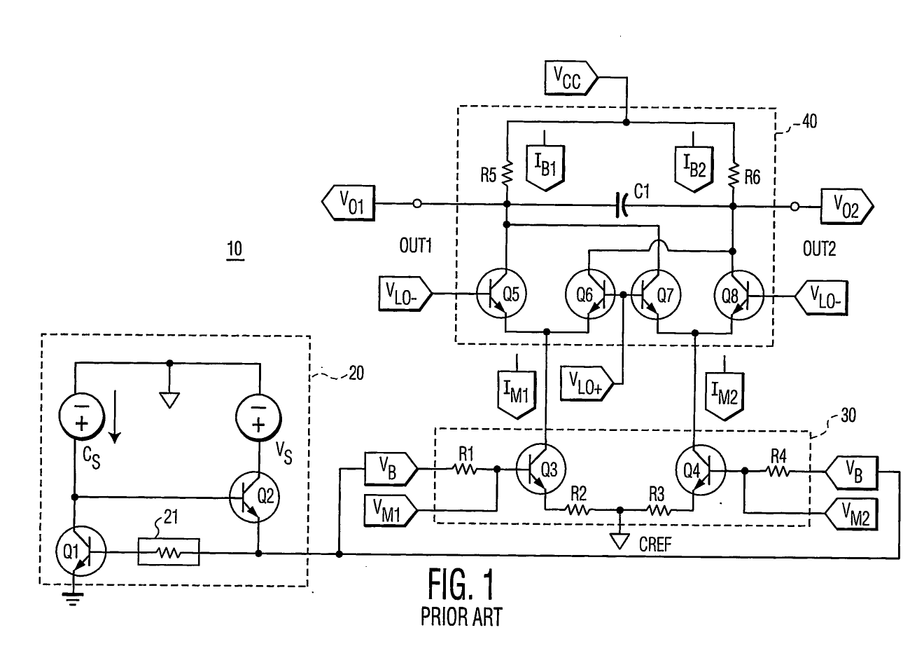

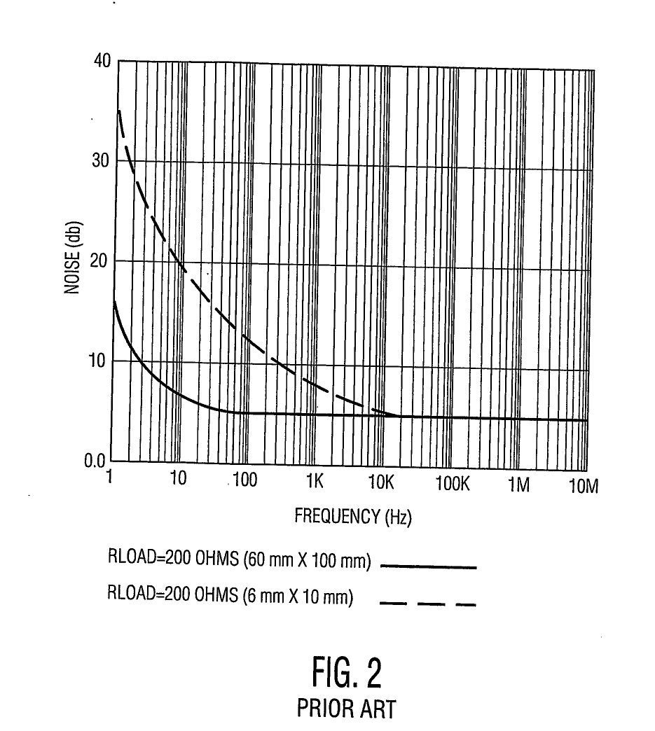

FIG. 1 illustrates a known ZIF down-conversion RF mixer 10 including a known Gilbert Cell arrangement consisting of npn bipolar transistors Q3-Q8. The Gilbert cell controls a differential output voltage V₀₁, V₀₂ generated between a pair of output terminals OUT1 and OUT2 as a function of a frequency differential between a frequency of a pair of mixing voltages V_{M1} and V_{M2} and a frequency of a pair of local oscillating voltages V_{LO+} and V_{LO-}. A pair of polysilicon resistors R5 and R6 are conventionally employed to provide biasing currents I_{B1} and I_{B2} to the Gilbert Cell. A flow of DC current through polysilicon resistors R5 and R6 via supply voltage V_{CC} results in a significant increase in a degree of noise in differential output voltage V₀₁, V₀₂ at a lower end of data baseband as exemplarily illustrated in FIG. 2. This noise at the lower end of the data baseband can impede a successful modulation or demodulation of data represented by differential output voltage V₀₁, V₀₂.

Thus, there is a need to minimize, if not eliminate, the noise contribution by polysilicon resistors R7 and R8 to differential output voltage V₀₁, V₀₂ at the lower end of the data baseband. One known solution is to increase the size of the polysilicon resistors R5 and R6. From the FIG. 2 illustration, it is observed that increasing the size of polysilicon resistors R5 and R6 can reduce the amount of noise contribution by polysilicon resistors R5 and R6 at the lower end of the data baseband. However, increasing the size of polysilicon resistors R5 and R6 may be impractical for most applications of the mixer. Furthermore, significant noise contribution by polysilicon resistors R5 and R6 can still exist between 1 Hz and 100 Hz as exemplarily illustrated in FIG. 2.

The present invention addresses the shortcomings with the prior art by providing a differential loading and a resistive bleeding that minimizes, if not eliminate, noise contribution to the differential output voltage of a mixer.

One form of the present invention is a mixer comprising a pair of output terminals, a Gilbert cell, and a polysilicon resistor. The Gilbert cell controls a differential output voltage between the output terminals. The polysilicon resistor applies a differential loading to the differential output voltage.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates a schematic diagram of a known mixer in accordance with one embodiment of the present invention;

FIG. 2 illustrates an operational relationship of noise and frequency of differential output voltage the FIG. 1 mixer;

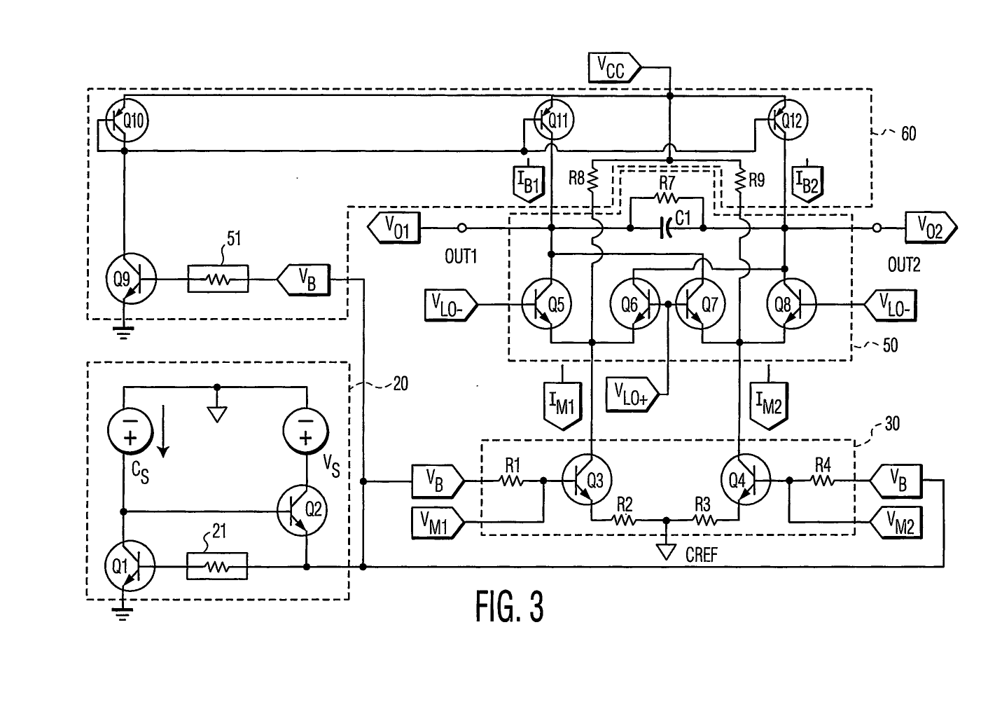

FIG. 3 illustrates a schematic diagram of a mixer in accordance with one embodiment of the present invention; and

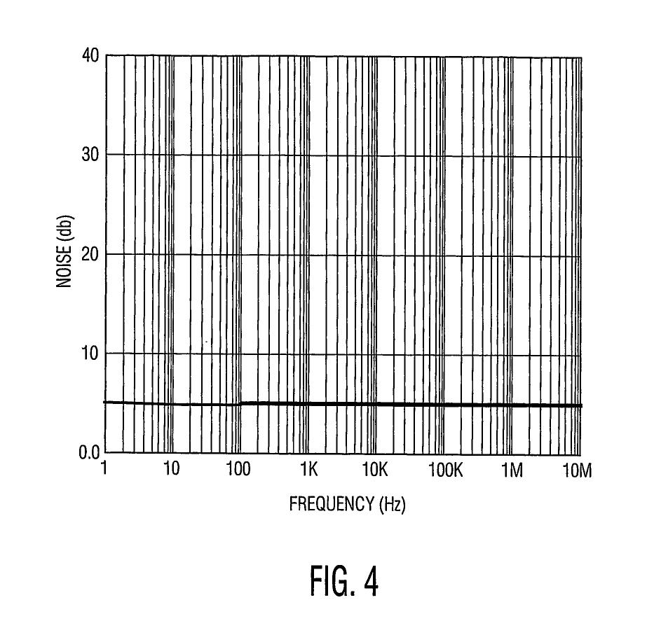

FIG. 4 illustrates an operational relationship of noise and frequency of differential output voltage of the FIG. 3 mixer.

The known mixer 10 includes a biasing stage 20, a differential gain stage 30, and a differential mixing stage 40 as illustrated in FIG. 1. Biasing stage 20 conventionally employs a current source C_{S}, a voltage source V_{S}, a npn bipolar transistor Q1, a resistor bank 21, and a npn bipolar transistor Q2 for generating a biasing voltage V_{B} at an emitter terminal of the transistor Q2.

The differential gain stage 30 employs a resistor R1, a npn bipolar transistor Q3, and a resistor R2 for pulling a mixing current I_{M1} from differential mixing stage 40 through a collector terminal and an emitter terminal of transistor Q3 to a common reference CREF. The differential gain stage 30 further employs a resistor R3, a npn bipolar transistor Q4, and a resistor R4 for pulling a mixing current I_{M2} from differential mixing stage 40 through a collector terminal and an emitter terminal transistor Q4 to the common reference CREF.

The differential mixing stage 40 employs polysilicon resistor R5 to provide a flow of biasing current I_{B1} from voltage supply V_{CC} through collector terminals and emitter terminals of transistors Q5 and Q7, and polysilicon resistor R6 to provide a flow of biasing current I_{B2} from voltage supply V_{CC} through collector terminals and emitter terminals of transistors Q6 and Q8.

A low pass filter of differential mixing stage 40 in the form of a capacitor C1 is coupled between output terminals OUT1 and OUT2 to define the data baseband, such as, for example, the data baseband illustrated in FIG. 2.

As previously described herein, a drawback in using polysilicon resistors R5 and R6 in the known single-ended loading manner is a contribution of 1/f noise to differential output voltage V_{O1}, V_{O2} when DC current is flowing through polysilicon resistors R5 and R6. As illustrated in FIG. 2, this noise contribution can be significant at frequencies near the lower end of the data baseband for the differential output voltage V_{O1}, V_{O2}.

FIG. 3 illustrates a new and unique ZIP down-conversion RF mixer 11 including the biasing stage 20 (FIG. 1), the differential gain stage 30 (FIG. 1), a differential mixing stage 50, and a differential biasing stage 60.

The differential mixing stage 50 employs transistors Q5-Q8 and capacitor C1 as previously described herein in connection with the description of FIG. 1. In lieu of polysilicon resistors R5 and R6 (FIG. 1), the differential biasing stage 60 employs a pair of current sources in the form of pnp bipolar transistors Q11 and Q12. Current source Q11 provides a flow of biasing current I_{B1} from supply voltage V_{CC} through collector terminals and emitter terminals of transistors Q5 and Q7, and current source Q12 provides a flow of biasing current I_{B2} from supply voltage V_{CC} through collector terminals and emitter terminals of transistors Q6 and Q8. Transistors Q11 and Q12 are current mirrors of a pnp bipolar transistor Q10 that is controlled by a npn bipolar transistor Q9 and a resistor bank 51, which receives the biasing voltage VB from the biasing stage 20.

The differential mixing stage 50 further employs a polysilicon resistor R7 coupled between the output terminals OUT1 and OUT2, and in parallel with capacitor C1. Polysilicon resistor R7 applies a differential loading to differential output voltage V_{O1}, V_{O2}. The result is a minimization, if not elimination, in the noise contribution by polysilicon resistor R7 to differential output voltage V_{O1}, V_{O2} as exemplarily illustrated in FIG. 4. From the illustration, it is observed that any noise contribution from polysilicon resistor R7 is dramatically minimized, if not eliminated, over the entire IF data baseband irrespective of the size of polysilicon resistor R7.

The differential biasing stage 60 further employs a resistor R8 and a resistor R9 for impeding a flow of DC current through current sources Q11 and Q12, respectively. The result is a minimization, if not elimination, in the noise contribution by resistors R8 and R9 to differential output voltage V_{O1}, V_{O2} as exemplarily illustrated in FIG. 4. From the illustration, it is observed that any noise contribution from current sources Q11 and Q12 are dramatically minimized, if not eliminated, over the entire IF data baseband. In one embodiment, resistors R8 and R9 can be polysilicon resistors.

It is important to note that FIG. 3 illustrates a specific application and embodiment of the present invention, and is not intended to limit the scope of the present disclosure or claims to that which is presented therein. Upon reading the specification and reviewing the drawings hereof, it will become immediately obvious to those skilled in the art that myriad other embodiments of biasing stage 20 (FIG. 3), differential gain stage 30 (FIG. 3), differential mixing stage S50 (FIG. 3), and differential biasing stage S60 (FIG. 3) are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A mixer (11), comprising:
a first output terminal (OUT1);
a second output terminal (OUT2);
a Gilbert cell (Q3-Q8) for controlling a differential output voltage between said first output terminal (OUT1) and said second output terminal (OUT2); and
a polysilicon resistor (R7) for applying a differential loading to the differential output voltage.

2. The mixer (11) of claim 1, further comprising:
a first current source (Q11) for providing a first biasing current to said Gilbert cell (Q3-Q8); and
a first resistor (R8) for impeding a flow of DC current through said first current source (Q11).

3. The mixer (11) of claim 2, wherein said first resistor (R8) is a polysilicon resistor.

4. The mixer (11) of claim 2, further comprising:
a second current source (Q12) for providing a second biasing current to said Gilbert cell (Q3-Q8); and
a second resistor (R9) for impeding a flow of DC current through said first current source (Q12).

5. The mixer (11) of claim 4, wherein said second resistor (R9) is a polysilicon resistor.

6. A method of operating a mixer (11), said method comprising:
operating a Gilbert cell (Q3-Q8) of the mixer (11) to control a differential output voltage between a pair of output terminals (OUT1, OUT2) of the mixer (11); and
operating a polysilicon resistor (R7) of the mixer (11) to apply a differential load to the differential output voltage.

7. The method of claim 6, further comprising:
operating a first current source (Q11) of the mixer (11) to provide a first biasing current to the Gilbert cell (Q3-Q8); and
operating a first resistor (R8) of the mixer (11) to impede a flow of DC current through the first current source (Q11).

8. The method of claim 7, further comprising:
operating a second current source (Q12) of the mixer (11) to provide a second biasing current to the Gilbert cell (Q3-Q8); and
operating a second resistor (R9) of the mixer (11) to impede a flow of DC current through the second current source (Q12).
